(19) United States
(12) Patent Application Publication
(10) Pub. No.: US 2011/0082743 A1
(43) Pub. Date: Apr. 7, 2011

(54) SYSTEM AND METHOD FOR PRESENTING CONTENT AT AN ELECTRONIC DEVICE WITH HIGH VIEWING PROBABILITY

(75) Inventor: Serge Rutman, Boulder Creek, CA (US)

(73) Assignee: FIRSTPAPER LLC, NEW YORK, NY (US)

(21) Appl. No.: 12/575,037

(22) Filed: Oct. 7, 2009

(51) Int. Cl. G06Q 30/00; G06F 17/30; G06N 5/02

(52) U.S. Cl. 705/14.49; 707/736; 706/47

(57) ABSTRACT

A system for and method for presenting content at an electronic device with high viewing probability is presented. The system and method for displaying content at an electronic reader device may comprise an acquisition module for receiving a plurality of electronic content from one or more content sources via a network, an identification module for identifying a high-viewing probability event at a electronic reader device, a selection module for selecting at least some of the plurality of electronic content for presentation, and a presentation module for presenting the electronic content at the electronic reader device in association with the high-viewing probability event.

### BACKGROUND INFORMATION

Periodicals often derive significant revenue from advertisers. Advertisements are typically printed in periodicals in order to be seen by potential consumers. For example, in a traditional periodical, such as a newspaper, a large advertisement on the front page is more likely to be viewed by a consumer (and therefore more expensive) than a small advertisement buried in the middle of the newspaper. An advertisement targeting those interested in sports will likely be more effective in a “sports” section of a newspaper periodical than in another section, such as an “arts” section. Some periodicals also strive to increase odds of particular advertisements being viewed by consumers by placing them on entire pages and/or on inserted sheets that fall out of the periodical. Therefore, statistical correlations exist between advertisement placement, size, and/or design and reader/consumer behavior. Although odds that an advertisement to be viewed by a consumer may be increased, conventional systems and method do not provide a technique for presenting content, such as advertisements, with high viewing probability in an electronic device.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 depicts a block diagram of a system for content distribution, according to an exemplary embodiment.

FIG. 2 depicts a module for presenting content at an electronic device content with high viewing probability, according to an exemplary embodiment.

FIG. 3A-3B depict content presentment configurations at an electronic device, according to exemplary embodiments.

FIG. 4 depicts an illustrative flowchart for presenting content at an electronic device with high viewing probability, according to an exemplary embodiment.

### DETAILED DESCRIPTION

Certain embodiments of the present invention provide electronic content access management on an electronic display device. More particularly, certain embodiments of the present invention provide a system for and method of managing electronic content access. Such electronic content may be accessed, by way of non-limiting example, via a device utilizing an electronic paper display, such as electrophoretic displays (“EPDs”) or electro-wetting displays. Examples of such displays include those disclosed in U.S. Pat. Nos. 6,577,433, 6,529,313, 6,525,866, 6,574,034, 6,017,584, 6,067,185, 6,118,426, 6,120,839, 6,124,851, 6,130,774, 6,172,798, 6,177,921, 6,232,950 and 6,249,271.

Electronic content may be presented at an electronic device with high viewing probability, regardless of what general topic/subject a particular user chooses to read/consume. This may be achieved by associating the electronic content (e.g., advertisements) with unavoidable or nearly unavoidable screens. For example, these may include a “power-on” screen, a “home” screen, a “transition” screen, a “time-out” screen, a “power-off” screen, an “off” screen, and/or other screen. A “power-on” screen may appear when an electronic device is initially activated and/or waiting to load an application, e.g., an operating system application. A “home” screen may be a default or menu screen. A “transition” screen may appear between transitions of electronic content, applications, and/or other transition. A “user-based” screen may appear when a user performs or does not perform one or more actions. For example, in the event a user has not interacted with content in an electronic device for a predetermined period of time (e.g., 3 minutes), a “user-based time out” screen may be displayed. Other user-based actions or inactions may also trigger a “user-based” screen. A “power-off” screen may appear when an electronic device is being powered off. An “off” screen may be displayed when an electronic device with a persistent display (e.g., an EPD) is not powered. By presenting electronic content (e.g., an advertisement) with at least one of these screens, an advertisement may be guaranteed to be presented and be more effectively targeted to consumers and have a high viewing probability.

In addition to presenting electronic content with high viewing probability, information relating to displayed electronic content may also be provided, stored, and/or reported. For example, when electronic content (e.g., an advertisement) is displayed at an electronic device, information relating to the displayed content, such as time of day/week/year of display, duration of display, geographical location(s) of electronic device during display, location of displayed electronic content on a screen, number of times displayed, and/or any related user actions to the displayed content (e.g., clicking a hyperlink, calling the advertiser if device is suitably equipped for making calls, bookmarking the advertisement, forwarding the advertisement to one or more friends, printing the advertisement, etc) may also be acquired. For example, an advertisement may be presented during user-initiated or system-initiated screens for a predetermined amount of cost. The cost for presenting the advertisement may be increased if the advertiser desires the advertisement to be presented for a longer period of time, within a larger advertisement space relative to the electronic display screen, or other variation. For instance, a short advertisement video that runs for approximately 15 seconds may be guaranteed to be presented at the electronic device for at least this entire duration. By identifying information related to the electronic content, business rules may be enhanced to further increase consumer viewing probability. Business rules may therefore be adjusted or fine-tuned based on estimated value in relation to various degrees of viewing probability or other factors. It should be appreciated that the information associated with the electronic data to be presented may be independently threaded or may be dependent on one another.

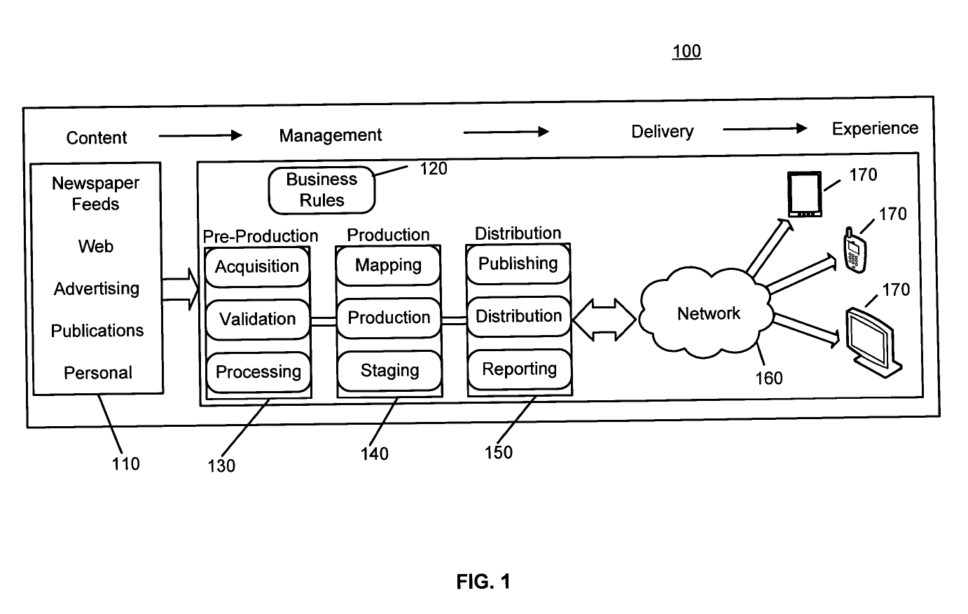

FIG. 1 depicts a block diagram of a system 100 for content distribution according to an embodiment of the invention. In some embodiments, the system 100 may by a content distribution system (“CDN”), which may include a content management system 110, a business rules system 120, a pre-production system 130, a production system 140, a distribution system 150 and one or more electronic devices 170. The distribution system 150 may distribute content to the one or more electronic devices 170 over a communications network 160. The communications network 160 may be any wired or wireless network. In one embodiment, the communication network may be an Internet Protocol (IP)-based network.

The content management system 110 may be communicatively coupled to the pre-production system 130, which in turn may be communicatively coupled to the production system 140. The production system 140 may be communicatively coupled to the distribution system 150. In some embodiments, content may be aggregated at the content management system 110 and outputted to the pre-production system 130 for validation and/or processing. The processed content may then be outputted from the pre-production system 130 and received at the production system 140 for mapping and/or staging. The mapped and staged content may then be outputted from the production system 140 and received at the distribution system 150 for publishing and/or distribution to the one or more electronic devices 170 over the communications network 160.

The pre-production system 130 may receive sourced content from the content management system 110 and output processed content to the production system 140. The production system 140 may received the processed content and output staged content to the distribution system 150. The distribution system 150 may receive the staged content and output approved content to one or more of the electronic devices 170.

The content management system 110 may include logic for gathering, aggregating, managing and/or storing content of various types. The types of content may include newspaper feeds, web content, advertising, publications, and/or personal information. In some embodiments, the content management system 110 may be configured to gather and/or aggregate content from one or more sources, categories, and/or content partners to the CDN 100 that provide content in association with the CDN 100. In some embodiments, the content may be gathered and/or aggregated automatically. In other embodiments, the content management system 110 may gather and/or aggregate the content based on one or more criteria. The criteria may include whether the content is perishable, curated, on-line, personal and/or other criteria.

The business rules system 120 may include a workflow engine configured to manage and/or execute modeled business processes. Each step in the operation of the workflow engine may be indicative of one or more business rules. The workflow engine may perform one or more actions based on the one or more business rules indicative of a specific template associated with a feed and/or publication in which content is received at the content management system 110. For example, in some embodiments, the one or more business rules may be completed for each article, publication, and/or advertisement processed through the workflow engine. In various embodiments, the business rules system 120 may include a workflow engine that operates according to one or more of the following rules: content enters the system through the feed; content is stored in a content repository, such as the content management system 110; various validation rules may be executed on the content; various pre-production rules are executed, the results of which may be stored back in the content management system 110; various production rules are executed, the results of which may be stored back in the content management system 110; the distribution system 150 may receive the results of the production system and distribute to electronic devices 170. In one embodiment, the CDN 100 may operate according to an amalgamation of the one or more business rules 120 as applied through the workflow engine.

Information relating to displayed content and/or related user actions may also be used by the business rules system 120 and/or other modules associated with electronic content distribution to enhance content delivery and presentment.

Exemplary content distribution networks are disclosed in U.S. application Ser. No. 12/248,482, titled “Systems, Methods and Apparatus for Content Distribution,” filed on Oct. 9, 2008 and U.S. provisional application No. 60/978,748, titled “Content Distribution and Preloading,” filed on Oct. 9, 2007, both of which are hereby incorporated by reference in their entireties.

It should be appreciated that the components/systems of the CDN 100 may be servers, network storage devices or other devices communicatively coupled to the communication network 160. In one or more embodiments, components/systems of the CDN 100 may perform any, or a combination, of storing, receiving, transmitting, producing, aggregating, and uploading electronic content. The components/systems of the CDN 100 may also perform other electronic content management functionality including, but not limited to, any, or a combination, of account management, electronic payment processing and verification, target marketing of electronic content to electronic display device users, user electronic content tracking, and content distribution.

In some embodiments, the components/systems of the CDN 100 may contain or be communicatively coupled to storage, such as a redundant array of inexpensive disks (RAID), a storage area network (SAN), an interne small computer systems interface (iSCSI) SAN, a Fibre Channel SAN, a common Internet File System (CIFS), network attached storage (NAS), a network file system (NFS), tape drive based storage, or other computer accessible storage.

Additionally, components/systems of the CDN 100 may communicate with any, or a combination, of other systems, applications, and storage locations directly via one or more of an Application Programming Interface (API), a Remote Procedure Call (RPC), an interface table, a web service, an Extensible Markup Language (XML) based interface, a Simple Object Access Protocol (SOAP) based interface, a common request broker architecture (CORBA) based interface, and other interfaces for sending or receiving information. For example, components/systems of the CDN 100 may communicate with accounting systems, marketing systems, interactive voice response (IVR) systems, systems of content providers, or other systems, servers, or components to facilitate electronic content caching and transactions.

Components/systems of the CDN 100 may each be responsible for different functionality in an electronic content distribution network. By way of non-limiting example, the components/systems of the CDN 100 may produce, receive, organize and aggregate electronic content, such as periodicals, books, newsletters, or other electronic content. Such electronic content may be aggregated from one or more feeds, such as publishers, resellers, newspapers, journalists, news services, broadcasts, or other sources. Processing of electronic content may include any, or a combination, of indexing, categorizing, storing, formatting, translating, filtering, spell checking, compressing, encrypting, securing, replicating, and further processing. Electronic content may be produced by user or third-party input (e.g., blogs, newsletters, etc.). Such content may be input via, by way of non-limiting example, typed input or dictations processed by speech to text input (e.g., text of speeches, conferences, proceedings, hearings, etc.). Electronic content may be produced by scanning existing text, such as by way of non-limiting example, by Optical Character Recognition (OCR) processes. Other scanning processes may produce electronic content without performing OCR processes. The components/systems of the CDN 100 may translate content from one format to another. For example, The components/systems of the CDN 100 may receive content from a subscriber and may translate the content into one or more electronic formats including, but not limited to, proprietary formats utilized by one or more e-book readers. The components/systems of the CDN 100 may receive subscriber or user content via emails, FTP (File Transfer Protocol), HTTP (Hyper Text Transfer Protocol), text message (e.g., via Short Message Service (SMS)), Multi-Media Messaging Service (MMS), Wireless Access Protocol (WAP), or via other electronic communication protocols. Categorization of content by the components/systems of the CDN 100 may include any, or a combination, of organizing content, storing content, and indexing content by one or more of a subject, subscription, and access. By way of non-limiting example, content may be grouped or stored in databases or other storage which may be separated according to subscription.

The network 160 may be any network, such as a local area network (LAN), a wide area network (WAN), a service provider network, the Internet, or other similar network. In some embodiments, the network 160 may be a service provider network. It should be appreciated that the network may use electric, electromagnetic, and/or optical signals that carry digital data streams.

The one or more electronic devices 170 may be electronic book (e-book) readers and/or E-Ink® devices. In other embodiments, the one or more electronic devices 170 may be desktop computers, laptops/notebooks, servers or server-like systems, modules, Personal Digital Assistants (PDAs), smart phones, cellular phones, mobile phones, satellite phones, MP3 players, video players, personal media players, personal video recorders (PVR), watches, gaming consoles/devices, navigation devices, televisions, printers, and/or other devices capable of receiving and/or transmitting signals and/or displaying electronic content. It should be appreciated that the network element 102 may be mobile, handheld, or stationary. It should also be appreciated that the one or more electronic devices 170 may be used independently or may be used as an integrated component in another device and/or system.

In some embodiments, electronic display devices 170 may access electronic content locally via one or more device interfaces. For example, the one or more electronic devices 170 may transmit and receive data to and from network 160 utilizing a standard telecommunications protocol or a standard networking protocol. By way of non-limiting example, one embodiment may utilize FTP (File Transfer Protocol), HTTP (Hyper Text Transfer Protocol), Wireless Application Protocol (WAP), Multimedia Messaging Service (MMS), Enhanced Messaging Service (EMS), Short Message Service (SMS), Global System for Mobile Communications (GSM) based systems, Transmission Control Protocol/Internet (TCP/IP) Protocols, or other protocols or systems suitable for transmitting and receiving electronic content data. Electronic content may be transmitted and received wirelessly or may utilize cabled network or telecom connections such as an Ethernet RJ45/Category 5 connection, a fiber connection, a traditional phone wireline connection, a cable connection or other wired network connection. The one or more electronic devices 170 may use standard wireless protocols including IEEE 802.11 and 802.16. The one or more electronic devices 170 may also be connected to network 102 via protocols for a wired connection, such as an IEEE Ethernet 802.3.

By way of non-limiting example, the one or more electronic devices 170 may also contain one or more interfaces including a USB (Universal Serial Bus) connection, an RS-232 or serial connection, a Bluetooth connection, an RFID (Radio Frequency IDentification) reader or interrogator, an RFID tag (active or passive), a firewire connection, or interfaces supporting storage media (e.g., flash memory cards, CDs, DVDs). Electronic content may be received by an end user on electronic storage media and may be loaded onto or accessed by an electronic display device via one or more interfaces.

It should also be appreciated that while the components/systems of the CDN 100 are shown as separate components, these may be combined into greater or lesser components to optimize flexibility. For example, while the content management system 110, pre-production system 130, production system 140, and distribution system 150 are depicted as separate components/systems, it should be appreciated that these components/systems may be integrated into a single component. Other various embodiments may also be realized.

It should be appreciated that each of the components/systems of the CDN 100 may be physical and/or virtual servers, modules, storage, devices, systems, etc. Each of the components/systems of the CDN 100 may also communicate with each other via one or more network communications. Other various embodiments may also be provided.

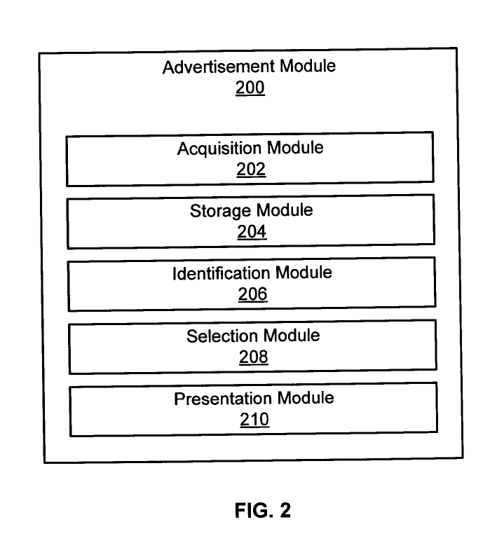

FIG. 2 depicts a module for presenting content at an electronic device content with high viewing probability, according to an exemplary embodiment. The module may be an advertisement module 200. The advertisement module 200 may be a part of the content management system 110, the pre-production system 130, the production system 140, the distribution system 150, and/or the one or more electronic devices of the CDN 100. The advertisement module 200 may implemented in hardware, software, or a combination thereof.

The advertisement module 200 may include a variety of other components/modules, such as an acquisition module 202, a storage module 204, an identification module 206, a selection module 208, a presentation module 210, and/or other modules. The acquisition module 202 may receive a plurality of electronic content (e.g., electronic advertisement content) from one or more content sources. The storage module 204 may store the received electronic content. The identification module 206 may identify one or more high-viewing probability events at an electronic device. The selection module 208 may select at least some of the plurality of electronic content for presentation. The presentation module 210 may present the electronic content at a display device in association with the high-viewing probability event.

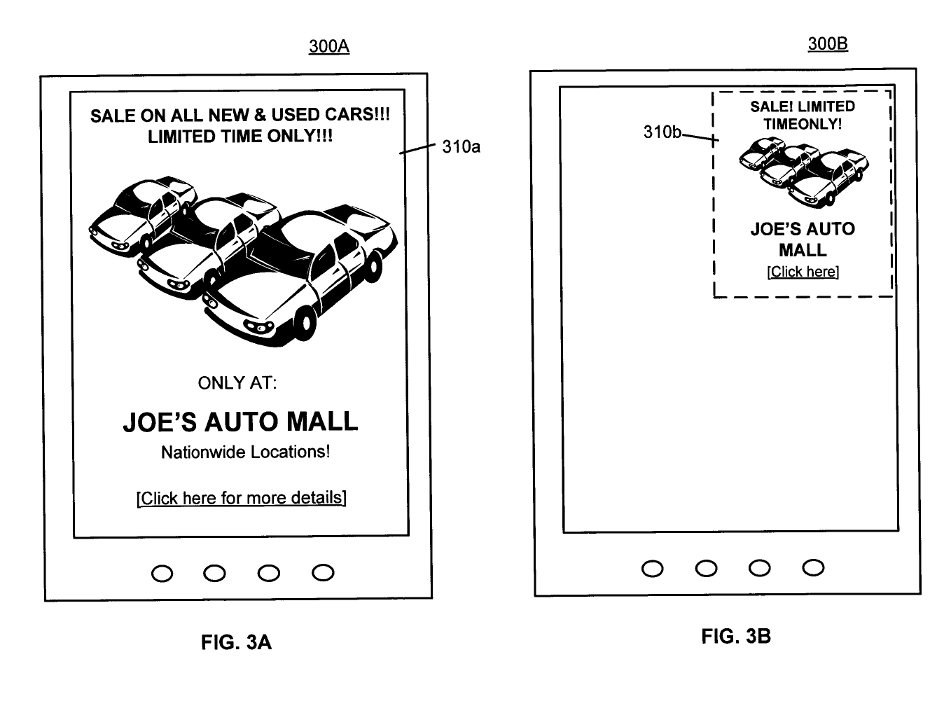

FIG. 3A-3B depict content presentment configurations at an electronic device, according to exemplary embodiments. For example, FIG. 3A depicts a full display configuration 300A of an electronic device 170 (e.g., an electronic content reader) with an advertisement 310a for “Joe's Auto Mall” on its display. As discussed above, the electronic advertisement content 310a may be presented at an electronic device with high viewing probability, regardless of what general topic/subject a particular user chooses to read/consume. This may be achieved by associating the electronic advertisement content (e.g., Joe's Auto Mall Sale) with nearly un-avoidable screens or events, which have high consumer viewing probability.

For example, when the electronic device 170 is turned or powered on, there may be “power-on” screen. While the electronic device 170 loads various applications (e.g., an operating system application), the electronic advertisement content 310a may be displayed as a “power-on” screen while the electronic device 170 is being activated and/or loading its operating system.

Another screen with high viewing probability is a “home” screen. Once the operating system loads, for example, a user may read various content. However, whenever the user wishes to go back to the “home” screen, which may provide a list of initial options, an electronic advertisement may be presented/displayed as a default or menu screen. This may greatly enhance consumer viewing probability.

A “transition” screen may also be used to display an electronic advertisement. For example, in an electronic reader or other similar device, a “transition” screen may appear between transitions of electronic content, applications, and/or other transition (e.g., switching from reading one e-book to another e-book). While the new e-book is loading, an electronic advertisement content 310a may be displayed. In some instances, an additional delay (e.g., 1, 2, 5, or 10 seconds) may be employed.

Another screen for presenting the electronic content may be based on how the user is interacting with the electronic device. For example, in the event a user has not interacted with content in an electronic device for a predetermined period of time (e.g., three (3) minutes), a “user-based time out” screen may be displayed. Other user-based actions or inactions may also trigger a “user-based” screen, such as turning it at a predetermined angle, pushing a button on the devices for a predetermined number of times, holding down a button on the device for a predetermined period time, etc.

A “power-off” screen may also be another way for the electronic advertisement content 310a to be displayed. Similar to the “power-on” screen, a “power-off” screen may appear when an electronic device is being powered off and all applications are being shut down.

It should be appreciated that with some electronic devices (e.g., those with persisten displays), an “off” screen may be able to displayed even when the devices is turned off. As a result, an “off” screen may be another screen to display the electronic advertisement content 310a. For example, the electronic device 170 may be powered off and the user may have set it aside on a table, for example, nevertheless, an advertisement may be “frozen” on the display of the device. Therefore, for the user and all others who walk by the table may have probability of viewing the advertisement, similar to that of a front page of a newspaper or magazine.

It should be appreciated that the electronic advertisement content 310a may also include hyperlinks and/or other interactivity option for a user to interact. For example, a user may click/touch a hyperlink to retrieve more information about the advertisement. Another example, a user interact with the electronic advertisement content 310a by physically printing out a coupon from a printer communicatively coupled the electronic device. Other various embodiments may also be provided.

FIG. 3B depicts a partial display configuration 300B of an electronic device 170 (e.g., an electronic content reader) with an advertisement 310b for “Joe's Auto Mall” on a portion of its display screen. In this embodiments, it should be appreciated that the advertisement may be displayed using a portion of the display. While only one advertisement 310b is depicted in the partial display configuration 300B, it should be appreciated that one or more additional electronic advertisement content may also be displayed in one of the high viewing probability screens. Moreover, the advertisement may be viewed concurrently with other non-advertisement content.

Although these high viewing probability screens do not depend on general topic/subject a particular user chooses to read/consume, acquiring information relating to displayed electronic content may be used to enhance viewing probability. For example, when electronic content (e.g., an advertisement) is displayed at an electronic device, information relating to the displayed content may be acquired. The information may include time of day/week/year of display, duration of display, geographical location(s) of electronic device during display, location of displayed electronic content on a screen, number of times displayed, and/or any related user actions to the displayed content. It should be appreciated that the related user actions may include clicking a hyperlink, calling the advertiser if device is suitably equipped for making calls, bookmarking the advertisement, forwarding the advertisement to one or more friends, printing the advertisement, etc. This information may be used to determine habits/trends of a user, for example, which may be used to further enhance viewing probability by consumers. In some embodiments, this information may be stored and processed by the advertisement module 200 to determine what advertisements to display and how to present them.

By identifying high viewing probability screens and/or acquiring information associated to the displayed content, odds that an advertisement will be viewed by a consumer may be increased. In addition to the benefits described above, embodiments of the system and method for presenting electronic advertisement content with high viewing probability not only provide an effective and improved technique for offering and selling products, but also may allow advertisers to more effectively service the consumer pool without any additional work. Moreover, advantages in business and marketing strategies may also become increasingly apparent. These benefits and opportunities may not otherwise be provided by conventional advertising techniques in electronic devices.

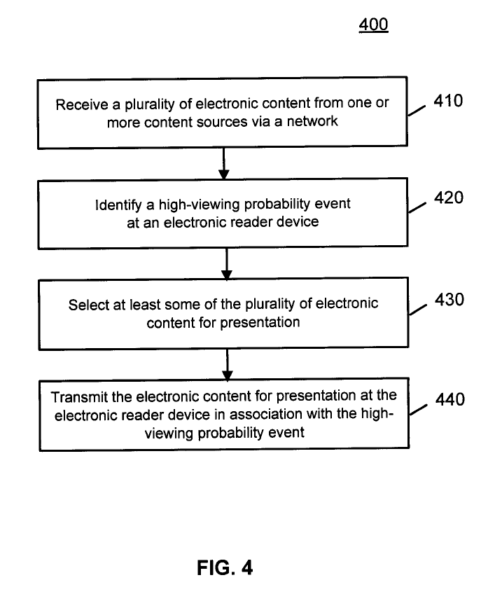

FIG. 4 depicts an illustrative flowchart of a method 400 for presenting content at an electronic device with high viewing probability, according to an exemplary embodiment. The exemplary method 400 is provided by way of example, as there are a variety of ways to carry out methods disclosed herein. The method 400 shown in FIG. 4 may be executed or otherwise performed by one or a combination of various systems. The method 400 is described below as carried out by at least system 100 in FIG. 1, by way of example, and various elements of system 100 are referenced in explaining the example method of FIG. 4. Each block shown in FIG. 4 represents one or more processes, methods, or subroutines carried in the exemplary method 400. A computer readable media comprising code to perform the acts of the method 300 may also be provided. Referring to FIG. 4, the exemplary method 400 may begin at block 410.

At block 410, the acquisition module 202 may receive a plurality of electronic content from one or more content sources via a network. In some embodiments, the electronic content may comprise advertisement content.

At block 420, the identification module 206 may identify a high-viewing probability event at a display device. In some embodiments, the high-viewing probability event may comprise at least one of a power-on screen, a home menu screen, a transition screen, a user-based screen, a power-off screen, an off screen, and/or other screen. The user-based screen may be a screen resulting from at least one of a user action and a user inaction.

At block 430, the selection module 208 may select at least some of the plurality of electronic content for presentation. In some embodiments, the selection module may select electronic content based on one or more selection rules.

At block 440, the presentation module may present the electronic content at a display device in association with the high-viewing probability event. In some embodiments, the presentation module may present electronic content based on one or more presentment rules.

It should also be appreciated that the method 400 may also store the plurality of electronic content in the storage module 204 and/or one or more additional storage units.

It should also be appreciated that information associated with the displayed content may also be identified, stored, reported, and/or outputted. For example, the information associated with the displayed content may include time the electronic content is displayed, date the electronic content is displayed, duration of the displayed electronic content, geographical location of the display device when the content is displayed, display position of the displayed electronic content at the display device, an interactive user action with the displayed electronic content, and/or other information. It should be appreciated that the interactive user action may include at least one of hyperlinking, bookmarking, emailing, forwarding, replying, printing, saving, and/or other action.

While the systems and methods are primarily directed to displaying electronic content (e.g., advertisements) at an EPD or electronic reader device, it should be appreciated that the features and functionalities of may be applied to other devices or display types as well. For example, the features and functionalities of the systems and methods may be implemented in other devices, such as computers, laptops, handheld devices, personal device assistants (“PDAs”), mobile phones, navigations systems, multimedia players, gaming devices, or other devices capable of transmitting or receiving electronic content. The features and functionalities of the systems and methods may be displayed on other static displays or even on volatile displays. Other static displays may include bichromal ball displays, interferometric modulator displays, cholesteric displays, bistable nematic liquid crystal displays, or other static displays. Volatile displays may include plasma displays, liquid crystal displays (“LCDs”), light emitting diode (“LED”) displays, organic light emitting diode (“OLED”) displays, electroluminescent displays (“ELDs”), digital light processing (“DLP”) displays, surface conduction electron-emitter displays (“SEDs”), field emission displays (“FEDs”), or other volatile display.

While the features and functionalities of the systems and methods are primarily directed to electronic advertisements, it should be appreciated that the features and functionalities of may be applied to other content as well. Furthermore, while the advertisement content is described primarily in a visual display, it should be appreciated that the content may include multimedia, audio, and/or other presentments.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

We claim:

1. A system for displaying content at an electronic reader device, comprising:
an acquisition module for receiving a plurality of electronic content from one or more content sources via a network;
an identification module for identifying a high-viewing probability event at a electronic reader device;
a selection module for selecting at least some of the plurality of electronic content for presentation; and
a presentation module for presenting the electronic content at the electronic reader device in association with the high-viewing probability event.

2. The system of claim 1, wherein the electronic content comprises advertisement content.

3. The system of claim 1, wherein the high-viewing probability event comprises at least one of a power-on screen, a home menu screen, a transition screen, a user-based screen, and a power-off screen. and an off screen.

4. The system of claim 3, wherein the user-based screen is a screen resulting from at least one of a user action and a user inaction.

5. The system of claim 1, wherein the high-viewing probability event is an off screen.

6. The system of claim 1, wherein the selection module selects electronic content based on one or more selection rules.

7. The system of claim 1, wherein the presentation module presents electronic content based on one or more presentment rules.

8. The system of claim 1, further comprising storing the plurality of electronic content in one or more storage units.

9. The system of claim 1, further comprising identifying information associated with the displayed electronic content.

10. The system of claim 9, wherein the information associated with the displayed content comprises at least one of time the electronic content is displayed, date the electronic content is displayed, duration of the displayed electronic content, geographical location of the electronic reader device when the content is displayed, display position of the displayed electronic content at the electronic reader device, and an interactive user action with the displayed electronic content.

11. The system of claim 10, wherein the interactive user action comprises at least one of hyperlinking, bookmarking, emailing, forwarding, replying, printing, and saving.

12. A method for displaying electronic content at an electronic reader device, comprising:
receiving, at an acquisition module using at least one computer processor, a plurality of electronic content from one or more content sources via a network;
identifying, at an identification module using the at least one computer processor, a high-viewing probability event at an electronic reader device;
selecting, at a selection module using the at least one computer processor, at least some of the plurality of electronic content for presentation; and
transmitting, by a presentation module using the at least one computer processor, the electronic content for presentation at the electronic reader device in association with the high-viewing probability event.

13. The method of claim 12, wherein the electronic content comprises advertisement content.

14. The method of claim 12, wherein the high-viewing probability event comprises at least one of a power-on screen, a home menu screen, a transition screen, a user-based screen, and a power-off screen.

15. The method of claim 14, wherein the user-based screen is a screen resulting from at least one of a user action and a user inaction.

16. The method of claim 12, wherein the high-viewing probability event is an off screen.

17. The method of claim 12, wherein the selection module selects electronic content based on one or more selection rules.

18. The method of claim 12, wherein the presentation module presents electronic content based on one or more presentment rules.

19. The method of claim 12, further comprising storing the plurality of electronic content in one or more storage units.

20. The method of claim 12, further comprising identifying information associated with the displayed content

21. The method of claim 20, wherein the information associated with the displayed content comprises at least one of time the electronic content is displayed, date the electronic content is displayed, duration of the displayed electronic content, geographical location of the electronic reader device when the content is displayed, display position of the displayed electronic content at the electronic reader device, and an interactive user action with the displayed electronic content.

22. The method of claim 21, wherein the interactive user action comprises at least one of hyperlinking, bookmarking, emailing, forwarding, replying, printing, and saving.

21. A computer readable medium comprising code to perform the acts of the method of claim 12.
